(19) United States
(12) Patent Application Publication
(10) Pub. No.: US 2026/0239082 A1
(43) Pub. Date: Aug. 13, 2026

(54) REPORTING OF DELAY STATUS REPORT

(71) Applicant: LENOVO (BEIJING) LIMITED, Beijing (CN)

(72) Inventors: Xiaoying XU, Beijing (CN); Mingzeng DAI, Beijing (CN); Jing HAN, Beijing (CN)

(21) Appl. No.: 19/471,109

(22) PCT Filed: Sep. 28, 2023
(86) PCT No.: PCT/CN2023/122839

§ 371 Date: Sep. 30, 2025

(51) Int. Cl. H04W 24/10; H04W 72/21; H04W 72/566

(52) U.S. Cl. CPC H04W 24/10; H04W 72/21; H04W 72/569

(57) ABSTRACT

Various aspects of the present disclosure relate to reporting of a DSR. In one aspect, a UE triggers reporting of a DSR and transmits the DSR to a base station. The DSR indicates delay status for a first set of LCGs. The first set of LCGs comprises one or more LCGs.

### TECHNICAL FIELD

The present disclosure relates to wireless communications, and more specifically to user equipment (UE), base station and methods for supporting reporting of a delay status report (DSR).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A DSR reporting procedure is used to provide a base station with delay status of uplink (UL) data. This delay status includes remaining time of UL data, which is based on a value of its associated timer at the time of the first symbol of the physical uplink shared channel (PUSCH) transmission in which the DSR is transmitted, as well as the amount of data associated with the reported remaining time. The reporting of the DSR may improve the UL scheduling. A Buffer Status reporting (BSR) procedure is used to provide a base station with information about UL data volume.

### SUMMARY

The present disclosure relates to UE, base station and methods that support reporting of a DSR. With the UE, base station and methods, a DSR for multiple logical channel groups (LCGs) may be reported.

Some implementations of a UE described herein may include a processor and a transceiver coupled to the processor, wherein the processor is configured to: trigger reporting of a DSR; and transmit, via the transceiver to a base station, the DSR indicating delay status for a first set of LCGs, the first set of LCGs comprising one or more LCGs.

In some implementations, each of the LCGs in the first set has a respective DSR available for transmission. Alternatively, in some implementations, each of the LCGs in the first set is configured with reporting of a respective DSR and has data available for transmission. Alternatively, in some implementations, each of the LCGs in the first set has data available for transmission.

In some implementations, the DSR comprises a first field comprising a first bitmap, and each of bits in the first bitmap is associated with one of LCGs and each of at least one of the bits indicates at least one of the following: whether a respective one of the LCGs has data available for transmission, or whether reporting of a respective DSR for the respective one of the LCGs is triggered, or whether a third field for the respective one of the LCGs is present in the DSR, the third field indicates a data volume of a set of data available for transmission in the respective one of the LCGs.

In some implementations, the LCGs are configured for the UE or configured with allowed reporting of DSRs.

In some implementations, the DSR comprises a second field comprising a second bitmap, each of bits in the second bitmap is associated with one of LCGs and each of at least one of the bits indicates whether reporting of a respective DSR for a respective one of the LCGs is triggered.

In some implementations, the DSR comprises a third field, and the third field indicates one of the following: a first data volume of a first set of data available for transmission in a respective one of the LCGs, remaining time of data in the first set of data being below a first remaining time threshold for the respective one of the LCGs, a second data volume of a second set of data available for transmission in the respective one of the LCGs, remaining time of data in the second set is below the first remaining time threshold and is the shortest among remaining time of data available for transmission in the one of the LCGs, a third volume of data available for transmission in the respective one of the LCGs, a respective DSR is not triggered or reporting of the respective DSR is not configured for the respective one of the LCGs, or a fourth data volume of a third set of data available for transmission in the respective one of the LCGs, remaining time of data in the third set of data is the shortest among remaining time of data available for transmission in the respective one of the LCGs, a respective DSR is not triggered or reporting of the respective DSR is not configured for the respective one of the LCGs.

In some implementations, the processor is further configured to: based on determining that the reporting of the DSR is triggered and reporting of a buffer status report (BSR) is triggered, transmit at least one of the DSR and the BSR in a decreasing order of priorities of the DSR and the BSR.

In some implementations, the processor is further configured to: determine a first priority of the DSR as a first highest priority of logical channels (LCHs) with delay status available for transmission in the first set of LCGs with delay status available for transmission; and determine a second priority of the BSR as a second highest priority of LCHs with data available for transmission in a second set of LCGs with data available for transmission, the second set of LCGs comprising one or more LCGs.

In some implementations, the processor is further configured to: determine the priorities of the DSR and the BSR based on types of the DSR and the BSR.

In some implementations, the processor is further configured to: based on determining that the reporting of the DSR is triggered for the first set of LCGs and reporting of a BSR is triggered for a second set of LCGs, transmit at least one of the DSR and the BSR in a decreasing order of the highest priority logical channel in each of the LCGs in the first and second sets of LCGs, the second set of LCGs comprising one or more LCGs.

In some implementations, the first set of LCGs comprises multiple LCGs, and the processor is further configured to: including data volume associated with delay status for the multiple LCGs in the DSR in a decreasing order of priorities of the multiple LCGs.

In some implementations, the processor is further configured to: determine a priority of a LCG among the multiple LCGs as a highest priority of logical channels (LCHs) with delay status available for transmission in the LCG.

In some implementations, the multiple LCGs comprise a first LCG and a second LCG, and the processor is configured to include the data volume associated with the delay status for the multiple LCGs by: based on determining that a first priority of the first LCG is equal to a second priority of the second LCG, including the data volume associated with remaining time of data in the first LCG and the second LCG in the DSR in an increasing order of one of the following: shortest remaining time of data in the first LCG and the second LCG, or remaining time thresholds associated with the first LCG and the second LCG.

In some implementations, the first set of LCGs comprises multiple LCGs, and the processor is further configured to include data volume associated with remaining time of data in the multiple LCGs in the DSR in an increasing order of one of the following: shortest remaining time of data in the multiple LCGs, or remaining time thresholds associated with the multiple LCGs.

In some implementations, the first set of LCGs comprises multiple LCGs, and the processor is further configured to: after including remaining time of data in the multiple LCGs in the DSR in a decreasing order of priorities of the multiple LCGs, including data volumes associated with the remaining time in the DSR in the decreasing order of the priorities of the multiple LCGs.

In some implementations, the first set of LCGs comprises multiple LCGs, and the processor is further configured to: before including remaining time of data in the multiple LCGs in the DSR in a decreasing order of priorities of the multiple LCGs, including data volumes associated with the remaining time in the DSR in the decreasing order of the priorities of the multiple LCGs.

In some implementations, the first set of LCGs comprises multiple LCGs, and the processor is further configured to: based on determining that an uplink grant is not enough to accommodate both remaining time of data for one of the multiple LCGs and a data volume associated with the remaining time, exclude at least one of the remaining time and the data volumes for the LCG.

Some implementations of a base station described herein may include a processor and a transceiver coupled to the processor, wherein the processor is configured to: transmit a configuration of a DSR via the transceiver to a UE; and receive, via the transceiver from the UE, the DSR indicating delay status for a first set of LCGs, the first set of LCGs comprising one or more LCGs.

Some implementations of a method described herein may include: triggering, at a UE, reporting of a DSR; and transmitting, to a base station, the DSR indicating delay status for a first set of LCGs, the first set of LCGs comprising one or more LCGs.

Some implementations of a method described herein may include: transmitting a configuration of a DSR to a UE; and receiving, from the UE, the DSR indicating delay status for a first set of LCGs, the first set of LCGs comprising one or more LCGs.

Some implementations of a processor described herein may include at least one memory and a controller coupled with the at least one memory and configured to cause the controller to: trigger reporting of a DSR; and transmit, to a base station, the DSR indicating delay status for a first set of LCGs, the first set of LCGs comprising one or more LCGs.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1 illustrates an example of a wireless communications system that supports reporting of a DSR in accordance with aspects of the present disclosure;

FIG. 2 illustrates a signaling diagram illustrating an example process that supports reporting of a DSR in accordance with aspects of the present disclosure;

FIG. 3 illustrates an example of a format of a DSR in accordance with aspects of the present disclosure;

FIG. 4 illustrates an example of remaining time of data available for transmission in an LCG in accordance with aspects of the present disclosure;

FIGS. 5 to 7 illustrates an example of a format of a DSR in accordance with aspects of the present disclosure, respectively;

FIG. 8 illustrates an example of part of LCGs with reporting of DSR being configured in accordance with aspects of the present disclosure;

FIG. 9 illustrates an example of prioritizing between DSR and BSR per LCG in accordance with aspects of the present disclosure;

FIGS. 10A, 10B and 10C illustrate an example of prioritizing of DSRs for multiple LCGs in accordance with aspects of the present disclosure, respectively;

FIG. 11 illustrates an example of a device that supports reporting of a DSR and discarding based on a synchronization transmission set in accordance with some aspects of the present disclosure; and

FIG. 12 illustrates an example of a processor that supports reporting of a DSR discarding based on a synchronization transmission set in accordance with aspects of the present disclosure; and

FIGS. 13 and 14 illustrate a flowchart of a method that supports reporting of a DSR in accordance with aspects of the present disclosure, respectively.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, the DSR reporting procedure is used to provide a base station with a delay status of UL data. A new separate MAC CE for DSR reporting may be defined. For example, DSR reporting may be not coupled with buffer status report (BSR) reporting. In addition, a UE may support threshold based DSR reporting. If a DSR is triggered for a logical channel group (LCG), and if more than one LCGs have data available for transmission, it needs to define the UE reports the DSR for which LCGs and how to design a format of the DSR.

In view of the above, the present disclosure provides a solution that supports reporting of a DSR. In this solution, a UE triggers reporting of a DSR and transmits the DSR to a base station. The DSR indicates delay status for a first set of LCGs. The first set of LCGs comprises one or more LCGs.

Aspects of the present disclosure are described in the context of a wireless communications system.

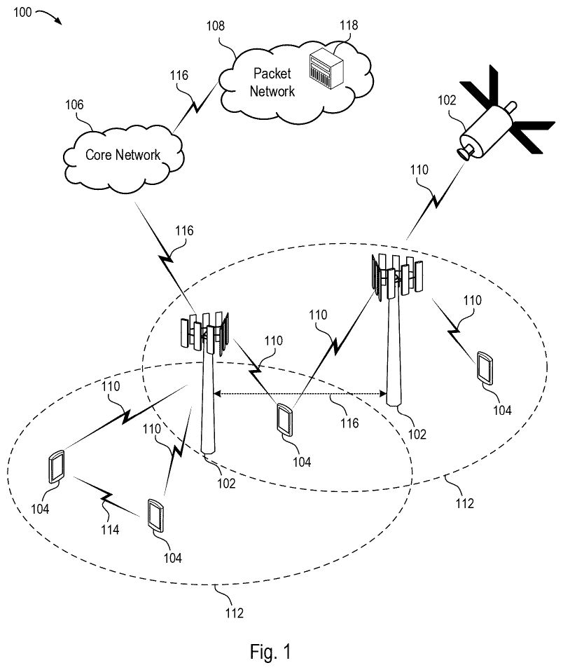

FIG. 1 illustrates an example of a wireless communications system 100 that supports reporting of a DSR in accordance with aspects of the present disclosure. The wireless communications system 100 may include one at least one of network entities 102 (also referred to as network equipment (NE)), one or more terminal devices or UEs 104, a core network 106, and a packet data network 108. The wireless communications system 100 may support various radio access technologies. In some implementations, the wireless communications system 100 may be a 4G network, such as an LTE network or an LTE-advanced (LTE-A) network. In some other implementations, the wireless communications system 100 may be a 5G network, such as an NR network. In other implementations, the wireless communications system 100 may be a combination of a 4G network and a 5G network, or other suitable radio access technology including institute of electrical and electronics engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The network entities 102 may be collectively referred to as network entities 102 or individually referred to as a network entity 102.

The network entities 102 may be dispersed throughout a geographic region to form the wireless communications system 100. One or more of the network entities 102 described herein may be or include or may be referred to as a network node, a base station (BS), a network element, a radio access network (RAN) node, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open radio access network (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN intelligent controller (RIC) (e.g., a near-real time RIC (Near-RT RIC), a non-real time RIC (Non-RT RIC)), a service management and orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), packet data convergence protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (510 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

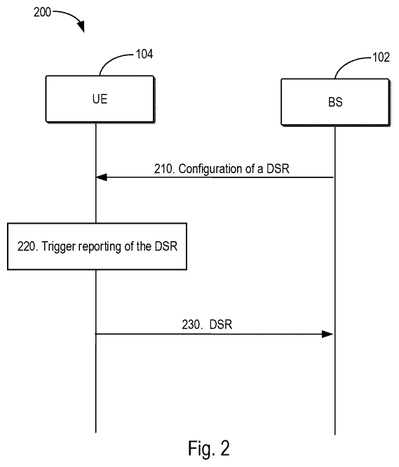

FIG. 2 illustrates a signaling diagram illustrating an example process 200 that supports reporting of a DSR in accordance with aspects of the present disclosure. The process 200 may involve the UE 104 and the base station 102 in FIG. 1. For the purpose of discussion, the process 200 will be described with reference to FIG. 1.

As shown in FIG. 2, the UE 104 receives 210 a configuration of a DSR from the base station 102.

In some implementations, the configuration of the DSR may comprise a remaining time threshold for triggering reporting of the DSR for an LCG.

In turn, the UE 104 triggers 220 reporting of the DSR based on the configuration of the DSR.

In some implementations, if an LCG is configured with allowed reporting of a DSR, the UE 104 triggers reporting of the DSR when remaining time of UL data in the LCG becomes less than or equal to its associated remaining time threshold of the LCG. If reporting of a DSR is triggered for an LCG, the LCG has a DSR available for transmission.

In some implementations, the UE 104 triggers reporting of the DSR for an LCG allowed to report DSR if there is no DSR triggered corresponding to the LCG and remaining time of UL data in the LCG becomes less than or equal to its associated remaining time threshold of the LCG.

In some implementations, the UE 104 triggers reporting of the DSR for an LCG allowed to report DSR if UL data of an LCH in the LCG becomes available to the MAC entity of the UE and remaining time of the UL data becomes less than or equal to its associated remaining time threshold of the LCG, and the UL data with a priority higher than the priority of any LCH containing available UL data or with triggered DSR which belong to the LCG.

In some implementations, the UE 104 triggers reporting of the DSR for an LCG allowed to report DSR if UL data of an LCH in the LCG becomes available to the MAC entity of the UE and remaining time of the UL data becomes less than or equal to its associated remaining time threshold of the LCG, and the UL data with a priority higher than the priority of any LCH containing available UL data or with triggered DSR which belong to any LCG allowed to report DSR.

In some implementations, the UE 104 triggers reporting of the DSR for an LCH in an LCG allowed to report DSR if there is no DSR triggered corresponding to the LCH and remaining time of UL data in the LCG becomes less than or equal to its associated remaining time threshold of the LCG. In some implementations, the UE 104 triggers reporting of the DSR for an LCH in an LCG allowed to report DSR if UL data of the LCH becomes available to the MAC entity of the UE 104 and remaining time of the UL data becomes less than or equal to its associated remaining time threshold of the LCG, and the UL data with a priority higher than the priority of any LCH containing available UL data or with triggered DSR which belong to any LCG allowed to report the DSR.

In some implementations, UL data in the LCG represents the UL data available for transmission in PDCP entity and/or RLC entity of the UE 104.

In some implementations, the UE 104 calculates the remaining time based on a value of a PDCP discard timer. These calculated values for the different PDU sets in the different logical channels can then be reported.

In some implementations, at reception of a PDCP SDU from upper layers, the transmitting PDCP entity starts the discard Timer associated with this PDCP SDU. When the discard Timer expires for a PDCP SDU, or the successful delivery of a PDCP SDU is confirmed by PDCP status report, the transmitting PDCP entity shall discard the PDCP SDU along with the corresponding PDCP Data PDU.

In some implementations, the UE 104 may receive a PDU set discard indication for a DRB from the base station 102. The indication indicates that all PDUs in a PDU set are to be discarded if any of the PDUs is not transmitted to the base station 102 successfully. In such implementations, the PDUs in the PDU set may have the same remaining time. For example, the remaining time of the PDUs may be the same as remaining time of a PDU in the PDU set which is first arrived at a PDCP entity of the UE 104.

Then, the UE 104 transmits 230 the DSR to the base station 102. The DSR indicates delay status for a first set of LCGs. The first set of LCGs comprises one or more LCGs.

In some implementations, each of the LCGs in the first set has a respective DSR available for transmission. In other words, reporting of a respective DSR is triggered for each of the LCGs in the first set. In such implementations, the UE 104 reports the DSR for all LCGs with reporting of DSRs being triggered if reporting of a DSR is triggered for an LCG. In this way, overhead for reporting of the DSR may be reduced compared to report the DSRs for all LCGs configured to allow to report DSR, for some of which no DSR is no triggered.

For example,

For DSR, the MAC entity shall:

| 1> | if more than one LCG has data available for transmission and/or has triggered | |
|---|---|---|
| | DSR when the MAC PDU containing the DSR is to be built: | |
| | 2> | report (Long) DSR for all LCGs which have data available for transmission |
| | | and have triggered DSR. |
| 1> | else: | |
| | 2> | report (Short) DSR. |

In such implementations, if only one LCG has a DSR available for transmission, the UE 104 reports the DSR for the LCG. The DSR may be a short DSR, which includes only DS for one LCG.

Alternatively, in such implementations, if more than one LCGs have DSRs available for transmission when a media access control (MAC) PDU containing the DSR is to be built, the UE 104 reports the DSR for all LCGs which have DSRs available for transmission. The DSR may be a long DSR, which includes DS for more than one LCGs.

In some implementations, if the data volume of an LCG with DSR triggered is zero, UE may not report DS for this LCG.

In some implementations, if the remaining time of an LCG with DSR triggered is zero, UE may not report DS for this LCG.

In some implementations, the UE 104 may transmit a MAC control element (CE) for the DSR to the base station 102. Hereinafter, a MAC CE for a DSR is also referred to as a DSR MAC CE for brevity.

In some implementations, data available for transmission is data pending for transmission in PDCP entity and/or RLC entity.

If the reporting of the DSR is triggered and not cancelled for an LCG, it represents the LCG has a DSR or DS available and pending for transmission. In some implementations, if the LCG has a DS available for transmission, the LCG has UL data and remaining time of at least one of the data in the LCG becomes less than or equal to its associated remaining time threshold. In some implementations, if the LCG has a DSR available for transmission or delay status (DS) available for transmission, it represents or implies the LCG has data available for transmission in PDCP entity and/or RLC entity and remaining time of one of the data in the LCG becomes less than or equal to its associated remaining time threshold of the LCG. In some implementations, UL data in the LCG represents UL data available and pending for transmission in PDCP and/or RLC in the LCG.

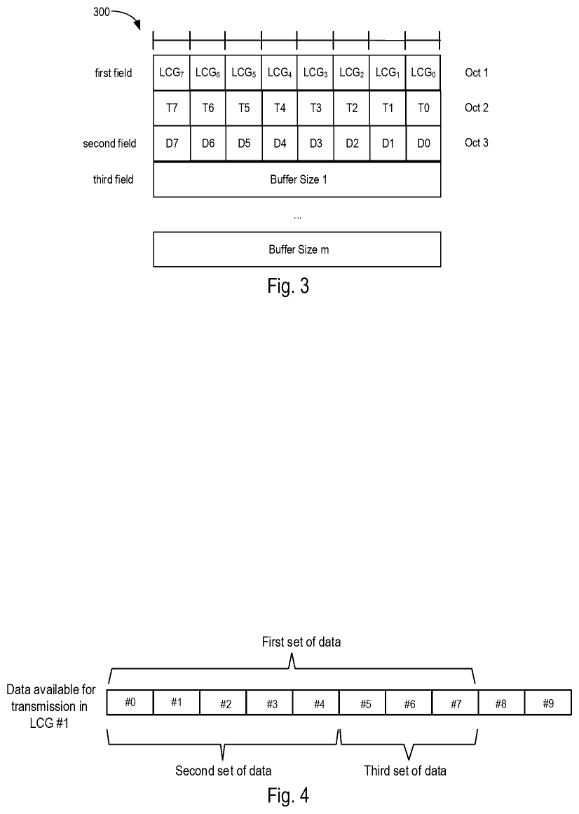

Hereinafter, some examples of a format of the DSR will be described with reference to FIGS. 3 to 5.

FIG. 3 illustrates an example 300 of a format of the DSR in accordance with aspects of the present disclosure. In the example 300, the DSR may comprise a first field comprising a first bitmap. Each of bits in the first bitmap is associated with one of LCGs and each of at least one of the bits indicates whether a respective one of the LCGs has data available for transmission. Hereinafter, the first field is also referred to as an LCGᵢ field.

In some implementations, the LCGᵢ field may indicate whether an LCGᵢ has data available for transmission, where i is an LCG ID configured for the UE 104.

For example, there are three LCGs configured for the UE 104: LCG #1, LCG #2, LCG #3. Only LCG #2 and LCG #3 are configured with reporting of DSR. In the LCG; field, LCG₁ is corresponding to LCG #1, LCG₂ is corresponding to LCG #2, and LCG₃ is corresponding to LCG #3.

In some implementations, the LCGᵢ field may indicate whether an LCGᵢ has data available for transmission, where i is the ascending order of the LCG identity (ID) among LCGs configured for the UE 104.

In some implementations, the first and the third fields are used to further indicate the delay status for the LCG.

In some implementations, the first, third and fourth fields are used to further indicate the delay status for the LCG.

In some implementations, the first, second and third fields are used to further indicate the delay status for the LCG.

In some implementations, the first, second, third and fourth fields are used to further indicate the delay status for the LCG.

For example, there are three LCGs configured for the UE 104: LCG #1, LCG #2, LCG #3. Only LCG #2 and LCG #3 are configured with reporting of DSR. In the LCGᵢ field, LCG₀ is corresponding to LCG #1, LCG₁ is corresponding to LCG #2, and LCG₂ is corresponding to LCG #3.

Alternatively, in some implementations, the LCG; field may indicate whether an LCGᵢ has data available for transmission, where i is the ascending order of the LCG ID among LCGs configured with allowed reporting of DSRs.

For example, there are three LCGs configured for the UE 104: LCG #1, LCG #2, LCG #3. Only LCG #2 and LCG #3 are configured with allowed reporting of DSRs. In the LCGᵢ field, LCG₀ is corresponding to LCG #2, LCG₁ is corresponding to LCG #3.

With continued reference to FIG. 3, the DSR may further comprise a second field comprising a second bitmap. Each of bits in the second bitmap is associated with one of LCGs and each of at least one of the bits indicates whether reporting of a respective DSR for a respective one of the LCGs is triggered. Hereinafter, the second field is also referred to as a Dᵢ field. The Dᵢ field may indicate whether reporting of a DSR for LCGᵢ is triggered. The Dᵢ field set to 1 indicates reporting of a DSR for LCG; is triggered. The Dᵢ field set to 0 indicates reporting of a DSR for LCG; is not triggered. In other words, the Dᵢ field may indicate presence or absence of a delay status for LCGᵢ.

As shown in FIG. 3, the DSR may further comprise a third field for an LCG. The third field is also referred to as a Buffer Size field i for LCG i. The third field is used to indicate the buffer status for an LCG. The Buffer Size field i may indicate a data volume calculated for LCGᵢ with reporting of DSR being triggered. In this case, the Dᵢ field may indicate presence or absence of a third field for LCG i. For example, if Dᵢ=1 and LCGᵢ=1 or if Dᵢ=1, Buffer Size field i is present for LCGᵢ. The third field is used to further indicate the delay status for the LCG.

Optionally, the DSR may further comprise a fourth field for an LCG. Presence of the fourth field may indicate the shortest remaining time or shortest value range associated the data volume for the LCG. The shortest remaining time or shortest value range may be identified by a code index in a table. The fourth field is used to further indicate the delay status for the LCG.

The third field may indicate a first data volume of a first set of data available for transmission in a respective one of the LCGs in the first set. Remaining time of data in the first set of data available for transmission is below a first remaining time threshold for the respective one of the LCGs. Alternatively, the third field may indicate a second data volume of a second set of data available for transmission in the respective one of the LCGs in the first set. Remaining time of data in the second set is below the first remaining time threshold and is the shortest among remaining time of data available for transmission in the one of the LCGs. This will be described with reference to FIG. 4 later.

The DSR may further comprise a Ti field. The Ti field indicates buffer size table information of the buffer size ID in the Buffer Size field i.

FIG. 4 illustrates an example 400 of remaining time of data available for transmission in an LCG in accordance with aspects of the present disclosure. In the example 400, an LCG #1 has packets #0 to 9 available for transmission. Among the packets #0 to 9 available for transmission, remaining time of packets #0 to 7 is less than or equal to a first remaining time threshold for the LCG #1. That is, a first set of packets comprises packets #0 to 7. The third field may indicate a first data volume of the first set of packets.

Alternatively, in some implementations, the first set of packets may comprise a second subset of packets and a third subset of packets. The second subset of packets comprises packets #0 to 4 and the second subset of packets comprises packets #5 to 7. Remaining time of packets #0 to 4 is less than or equal to remaining time of packets #5 to 7. In other words, the remaining time of packets #0 to 4 is the shortest among remaining time of packets #0 to 9 available for transmission in the LCG #1. In such implementations, the third field may indicate a second data volume of the second subset of packets.

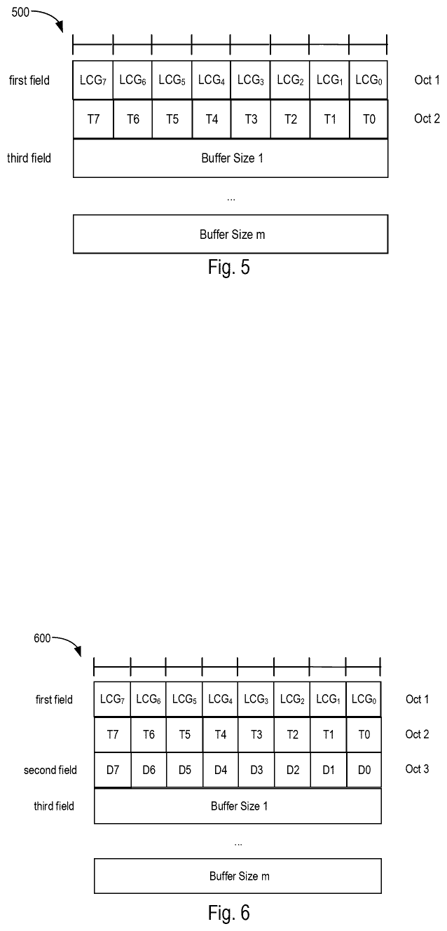

FIG. 5 illustrates an example 500 of a format of the DSR in accordance with aspects of the present disclosure. In the example 500, the DSR may comprise a first field (i.e., the LCG; field). The first field in the example 500 has a combined function of the first field and the second field in the example 300.

Specifically, the first field comprises a first bitmap. Each of bits in the first bitmap is associated with one of LCGs and each of at least one of the bits indicates whether reporting of a respective DSR for the respective one of the LCGs is triggered. And/or, each of at least one of the bits in the first bitmap indicates whether a third field for the respective one of the LCGs is present in the DSR. The third field indicates a data volume of a set of data available for transmission in the respective one of the LCGs.

For example, the LCGᵢ field may indicate whether reporting of a DSR for LCG; is triggered, where i is an LCG ID or i is the ascending order of the LCG ID among LCGs configured for the UE 104. Alternatively, the LCG; field may indicate whether reporting of a DSR for LCGᵢ is triggered, where i is the ascending order of the LCG ID among LCGs configured with allowed reporting of DSRs. The LCGᵢ field set to 1 indicates reporting of a DSR for LCGᵢ is triggered. The LCGᵢ field set to 0 indicates reporting of a DSR for LCGᵢ is not triggered. The LCGᵢ field may also indicate presence or absence of a third field for LCGj. The LCGᵢ field set to 1 indicates presence of a third field for LCGᵢ. The LCGᵢ field set to 0 indicates absence of a third field for LCGᵢ.

As shown in FIG. 5, the DSR may further comprise a third field. The third field is also referred to as a Buffer Size field i for LCG i. The Buffer Size field i may indicate a data volume calculated for LCG; with reporting of DSR being triggered. For example, if LCGᵢ=1, Buffer Size field i is present for LCGᵢ.

The third field may indicate a first data volume of a first set of data available for transmission in a respective one of the LCGs in the first set. Remaining time of data in the first set of data is below a first remaining time threshold for the respective one of the LCGs. Alternatively, the third field may indicate a second data volume of a second set of data available for transmission in the respective one of the LCGs in the first set. Remaining time of data in the second set is below the first remaining time threshold and is the shortest among remaining time of data available for transmission in the one of the LCGs, as described above with reference to FIG. 4.

Alternatively, in some implementation, the first field comprises a first bitmap. Each of bits in the first bitmap is associated with one of LCGs and each of at least one of the bits indicates whether reporting of a respective DSR for the respective one of the LCGs is triggered. Alternatively or additionally, each of at least one of the bits in the first bitmap indicates indicate presence or absence of a delay status for LCGᵢ in the DSR.

For example, each bit indicates whether a third field and a fourth field for the respective one of the LCGs is present in the DSR. The LCGᵢ field may also indicate presence or absence of a third field and fourth field for LCGᵢ. The LCGᵢ field set to 1 indicates presence of a third field and fourth for LCGᵢ. The LCGᵢ field set to 0 indicates absence of a third field and fourth field for LCGᵢ.

The DSR may further comprise a Ti field. The Ti field indicates buffer size table information of the buffer size ID in the Buffer Size field i for the LCG i.

Alternatively, in some implementations, each of the LCGs in the first set may be configured with reporting of a respective DSR and has data available and pending for transmission. In this case, the reporting of DSR may be triggered or not triggered for one of the LCGs. In such implementations, if only one LCG among the LCGs configured with allowed reporting of DSR has data available for transmission, the UE 104 reports a DSR for the LCG. The DSR may be a short DSR.

Alternatively, if more than one LCGs have data available for transmission or if more than one LCGs have DSRs available for transmission when the MAC PDU containing the DSR is to be built, the UE 104 reports a DSR for all LCGs which have data available for transmission and which are configured with allowed reporting of DSR. The DSR may be a long DSR. In this case, the reporting of DSR may be triggered or not triggered for one of the LCGs.

For example,

For DSR, the MAC entity shall:

| 1> | if more than one LCG has data available for transmission and/or has triggered | |
|---|---|---|
| | delay status for transmission when the MAC PDU containing the DSR is to be | |
| | built: | |
| | 2> | report Long DSR for all LCGs which have data available for transmission |
| | | and are configured with reporting of delay status report. |
| 1> | else: | |
| | 2> | report Short DSR. |

FIG. 6 illustrates an example 600 of a format of the DSR in accordance with aspects of the present disclosure. In the example 600, the DSR may comprise a first field comprising a first bitmap. Each of bits in the first bitmap is associated with one of LCGs and each of at least one of the bits indicates whether a respective one of the LCGs has data available for transmission. Hereinafter, the first field is also referred to as an LCGᵢ field.

In some implementations, each of bits in the first bitmap is associated with one of LCGs and each of at least one of the bits indicates whether presence or absence of third field of a respective one of the LCGs. The LCG; field may indicate presence or absence of a third field of an LCGᵢ, where i is an LCG ID or i is the ascending order of the LCG identity (ID) among LCGs configured for the UE 104.

In some implementations, the LCGᵢ field may indicate whether an LCG; has data available for transmission, where i is an LCG ID or i is the ascending order of the LCG identity (ID) among LCGs configured for the UE 104.

Alternatively, in some implementations, the LCG; field may indicate whether an LCGᵢ has data available for transmission, where i is the ascending order of the LCG ID among LCGs configured with allowed reporting of DSRs.

In the example 600, the DSR may further comprise a second field comprising a second bitmap. Each of bits in the second bitmap is associated with one of LCGs and each of at least one of the bits indicates whether reporting of a respective DSR for a respective one of the LCGs is triggered. Hereinafter, the second field is also referred to as a Dᵢ field. The Dᵢ field may indicate whether reporting of a DSR for LCG; is triggered. The Dᵢ field set to 1 indicates reporting of a DSR for LCGᵢ is triggered. The Dᵢ field set to 0 indicates reporting of a DSR for LCG; is not triggered. In other words, the Dᵢ field may indicate presence or absence of a delay status for LCGᵢ.

In the example 600, the DSR may further comprise a third field. The third field is also referred to as a Buffer Size field i for LCG i.

In some implementations, similar to the third field in the example 300, the third field may indicate a first data volume of a first set of data available for transmission in a respective one of the LCGs in the first set. Remaining time of data in the first set of data is below a first remaining time threshold for the respective one of the LCGs. Alternatively, the third field may indicate a second data volume of a second set of data available for transmission in the respective one of the LCGs in the first set. Remaining time of data in the second set is below the first remaining time threshold and is the shortest among remaining time of data available for transmission in the one of the LCGs.

For example, the third field indicates a data volume for the LCG with remaining time less than or equal to the remaining time threshold or the total amount of data available for transmission in the LCG corresponding to the shortest remaining time if reporting of the DSR is triggered for the LCG, i.e., D₀=1 and LCG₀=1.

Alternatively, in some implementations, the third field may indicate a third volume of data available for transmission in the respective one of the LCGs if reporting of a respective DSR is not triggered for a respective one of the LCGs.

For example, the third field indicates a total data volume calculated for the LCG if the DSR is not triggered for the LCG, i.e., D₀=0 and LCG₀=1.

Alternatively, in some implementations, the third field may indicate a fourth data volume of a third set of data available for transmission in the respective one of the LCGs and remaining time of data in the third set of data is the shortest among remaining time of data available for transmission in the respective one of the LCGs if reporting of a respective DSR is not triggered for the respective one of the LCGs.

For example, the third field indicates a data volume calculated for an LCG corresponding to shortest remaining time if the DSR is not triggered for the LCG, i.e., D₀=0 and LCG₀=1. Optionally, a fourth field is present to indicate the shortest remaining time or shortest value range associated the data volume for the LCG. The shortest remaining time or shortest value range may be identified by a code index in a table.

The DSR may further comprise a Ti field. The Ti field indicates buffer size table information of the buffer size ID in the Buffer Size field i.

In some implementations, each of bits in the second bitmap is associated with one of LCGs and each of at least one of the bits indicates whether presence or absence of third field and fourth field of a respective one of the LCGs. The LCGᵢ field may indicate presence or absence of third field and fourth field of an LCGᵢ, where i is an LCG ID or i is the ascending order of the LCG ID among LCGs configured for the UE 104.

Hereinafter, the second field is also referred to as a Dᵢ field. The Dᵢ field may indicate whether reporting of a DSR for LCGᵢ is triggered. The Dᵢ field set to 1 indicates reporting of a DSR for LCGᵢ is triggered. The Dᵢ field set to 0 indicates reporting of a DSR for LCGᵢ is not triggered. In other words, the Dᵢ field may indicate presence or absence of a fourth field for LCGᵢ. For example, if D₀=0 and LCG₀=1, the third field for the LCG is present and the fourth field is absent in the DSR. For example, if D₀=1 and LCG₀=1, both the third field and the fourth field are present in the DSR.

Alternatively, in some implementations, each of the LCGs in the first set has data available for transmission if reporting of a DSR is triggered for one of the LCGs.

In some implementations, if reporting of a DSR is triggered and if more than one LCGs have data available for transmission or if more than one LCGs have DSRs available for transmission when the MAC PDU containing a DSR is to be built, the UE 104 reports the DSR for all LCGs which have data available for transmission (and which are configured or not configured with allowed reporting of DSRs).

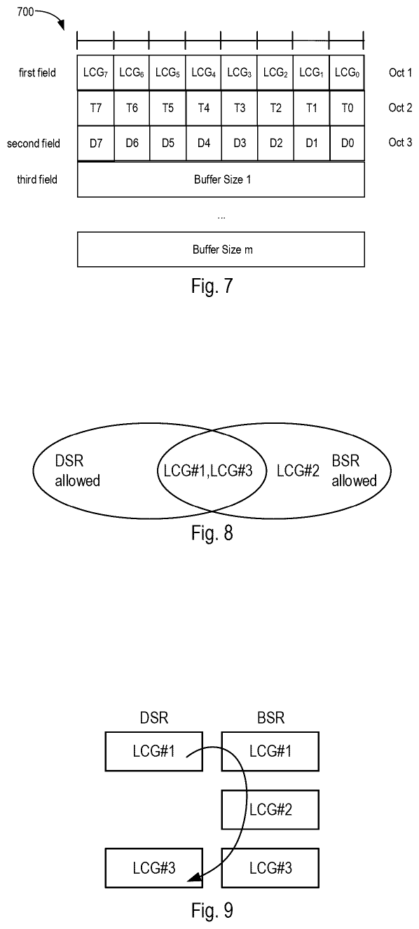

FIG. 7 illustrates an example 700 of a format of the DSR in accordance with aspects of the present disclosure. In the example 700, the DSR may comprise a first field (i.e., an LCGᵢ field) comprising a first bitmap. Each of at least one of the bits in the first bitmap indicates whether a third field (i.e., a Buffer Size field i) for the respective one of the LCGs is present in the DSR. For example, the LCGᵢ field may indicate whether a Buffer Size field i for an LCG; is present in the DSR, where i is LCG i or the ascending order of the LCG ID among LCGs configured for the UE 104.

In the example 700, the DSR may further comprise a second field (i.e., a Dᵢ field) comprising a second bitmap. Each of bits in the second bitmap is associated with one of LCGs and each of at least one of the bits indicates whether reporting of a respective DSR for a respective one of the LCGs is triggered. For example, the Dᵢ field may indicate whether reporting of a DSR for LCG; is triggered. The Dᵢ field set to 1 indicates reporting of a DSR for LCGᵢ is triggered. The Dᵢ field set to 0 indicates reporting of a DSR for LCGᵢ is not triggered or not configured.

Alternatively, in some implementations, the DSR may further comprise a second field (i.e., a Dᵢ field) comprising a second bitmap. Each of bits in the second bitmap is associated with one of LCGs and each of at least one of the bits indicates whether reporting of a respective DSR for a respective one of the LCGs is triggered. For example, the Dᵢ field may indicate whether reporting of a DSR for LCG; is triggered. The Dᵢ field set to 1 indicates reporting of a DSR for LCGᵢ is triggered. The Dᵢ field set to 0 indicates reporting of a DSR for LCG; is not triggered or not configured. In other words, the Dᵢ field may indicate whether presence or absence of the fourth field for LCGᵢ. The Dᵢ field set to 1 indicates presence or presence of the fourth field f for LCGᵢ in the DSR. The Dᵢ field set to 0 indicates presence or absence of the fourth field in the DSR. For example, if D₀=0 and LCG₀=1, a fourth field for the LCG is absent. f D₀=1 and LCG₀=1, a fourth field for the LCG is present.

In the example 700, the DSR may further comprise a third field (i.e., a Buffer Size field i). Optionally, presence of a fourth field may indicate the shortest remaining time or shortest value range associated the data volume for the LCG. The shortest remaining time or shortest value range may be identified by a code index in a table.

In some implementations, similar to the third field in the example 300, the third field may indicate a first data volume of a first set of data available for transmission in a respective one of the LCGs in the first set. Remaining time of data in the first set of data is below a first remaining time threshold for the respective one of the LCGs. Alternatively, the third field may indicate a second data volume of a second set of data available for transmission in the respective one of the LCGs in the first set. Remaining time of data in the second set is below the first remaining time threshold and is the shortest among remaining time of data available for transmission in the one of the LCGs.

For example, the third field indicates a data volume for the LCG with remaining time less than or equal to the remaining time threshold or the total amount of data available for transmission in the LCG corresponding to the shortest remaining time if reporting of the DSR is triggered for the LCG, i.e., D₀=1 and LCG₀=1. Optionally, presence of a fourth field may indicate the shortest remaining time or shortest value range associated the data volume for the LCG. The shortest remaining time or shortest value range may be identified by a code index in a table.

Alternatively, in some implementations, the third field may indicate a third volume of data available for transmission in the respective one of the LCGs if reporting of a respective DSR is not triggered or reporting of the respective DSR is not configured for a respective one of the LCGs.

For example, the third field indicates a total data volume calculated for the LCG if the DSR is not triggered for the LCG, i.e., D₀=0 and LCG₀=1. In this case, DSR reporting is configured for the LCG.

Alternatively, in some implementations, the third field may indicate a fourth data volume of a third set of data available for transmission in the respective one of the LCGs and remaining time of data in the third set of data is the shortest among remaining time of data available for transmission in the respective one of the LCGs if reporting of a respective DSR is not triggered or reporting of the respective DSR is not configured for the respective one of the LCGs.

For example, the third field indicates a data volume calculated for an LCG corresponding to shortest remaining time if the DSR is not triggered for the LCG, i.e., D₀=0 and LCG₀=1. Optionally, a fourth field is present to indicate the shortest remaining time or shortest value range associated the data volume for the LCG. The shortest remaining time or shortest value range may be identified by a code index in a table. In some implementations, both reporting of a DSR and reporting of a BSR may be triggered. In such implementations, the UE 104 may transmit at least one of the DSR and the BSR in a decreasing order of priorities of the DSR and the BSR. The UE 104 may prioritize the DSR MAC CE and BSR MAC CE with a higher priority during a MAC PDU assembling. For example, if a UL grant is not enough to accommodate both of the DSR and the BSR, the UE 104 may prioritize the DSR MAC CE and BSR MAC CE with a higher priority during a MAC PDU assembling.

In some implementations, the UE 104 may determine a first priority of the DSR as a first highest priority of LCHs with delay status available for transmission in the first set of LCGs with delay status available for transmission. In addition, the UE 104 may determine a second priority of the BSR as a second highest priority of logical channels (LCHs) with data available for transmission in a second set of LCGs with data available for transmission. The second set of LCGs comprises one or more LCGs.

FIG. 8 illustrates an example of part of LCGs with reporting of DSR being configured in accordance with aspects of the present disclosure. In the example of FIG. 8, a priority of LCG #1 is higher than a priority of LCG #2, and the priority of LCG #2 is higher than a priority of LCG #3. LCG #1 and LCG #3 are configured with reporting of BSR. DSR is trigged for LCG #3, BSR is triggered for LCG #1 and LCG #3. The UE 104 may prioritize the BSR for transmission.

In some implementations, the UE 104 may determine a priority of an LCG with delay status available for transmission as the highest priority of LCHs with delay status available for transmission in the LCG.

In some implementations, if the first priority of the DSR is equal to the second priority of the BSR, the UE 104 may prioritize the DSR or BSR based on implementation of the UE 104. Alternatively, it may be pre-defined that the UE 104 prioritizes the DSR or prioritizes the BSR.

Alternatively, in some implementations, the UE 104 may determine the priorities of the DSR and the BSR based on types of the DSR and the BSR.

In some implementations, a type of the DSR may be one of the following: a Regular DSR, a Periodic DSR or a Padding DSR.

In some implementations, if the UE 104 triggers reporting of the DSR when remaining time of UL data in an LCG becomes less than or equal to its associated remaining time threshold, the triggered DSR may be a Regular DSR.

In some implementations, UL resources are allocated and the number of padding bits is equal to or larger than the size of the DSR MAC CE plus its subheader, the DSR is referred to as a Padding DSR.

In some implementations, priorities between Regular/Periodic/Padding DSR and legacy Regular/Periodic/Padding BSR or new enhanced BSR (EBSR) may be defined as shown in Table 1.

TABLE 1

| | Regular BSR | Periodic BSR | Padding BSR |
|---|---|---|---|
| Regular DSR | >, ==, or < | >, ==, or < | >, ==, or < |
| Padding DSR | >, ==, or < | >, ==, or < | >, ==, or < |
| Periodic DSR | >, ==, or < | >, ==, or < | >, ==, or < |

In Table 1, “>” represents a priority of a BSR is higher than a priority of a DSR or a priority of a DSR is higher than a priority of a BSR, “==” represents a priority of a BSR is equal to a priority of a DSR, and “<” represents a priority of a BSR is lower than a priority of a DSR or a priority of a DSR is lower than a priority of a BSR.

In some implementations, it is not preferred that a priority of a Regular DSR is equal to a priority of a Padding BSR.

In some implementations, it is not preferred that a priority of a Regular DSR is lower than a priority of a Padding BSR.

In some implementations, it is not preferred that a priority of a Padding DSR is higher than a priority of a Regular BSR.

In some implementations, it is not preferred that a priority of a Padding DSR is equal to a priority of a Regular BSR.

In some implementations, it is not preferred that a priority of a Periodic DSR is lower than a priority of a Padding BSR.

In some implementations, it is not preferred that a priority of a Periodic DSR is equal to a priority of a Padding BSR.

Alternatively, in some implementations, if the reporting of the DSR is triggered for the first set of LCGs and reporting of a BSR is triggered for a second set of LCGs, the UE 104 may transmit at least one of the DSR and the BSR in a decreasing order of the highest priority logical channel in each of the LCGs in the first and second sets of LCGs, the second set of LCGs comprising one or more LCGs.

In such implementations, the highest priority logical channel in each of the LCGs in the first set of LCGs has delay status available for transmission. In such implementations, the highest priority logical channel in each of the LCGs in the second set of LCGs has data available for transmission.

In such implementations, the UE 104 may determine a first priority of the DSR as a first highest priority of LCHs with delay status available for transmission in the first set of LCGs with delay status available for transmission. In addition, the UE 104 may determine a second priority of the BSR as a second highest priority of LCHs with data available for transmission in a second set of LCGs with data available for transmission. The second set of LCGs comprises one or more LCGs.

FIG. 9 illustrates an example of prioritizing between DSR and BSR per LCG in accordance with aspects of the present disclosure. In the example of FIG. 9, a priority of LCG #1 is higher than a priority of LCG #2, and the priority of LCG #2 is higher than a priority of LCG #3. The UE 104 first prioritizes the DSR and BSR for LCG #1, then BSR for LCG #2, at last the DSR and BSR for LCG #3.

In some implementations, as described above with reference to FIGS. 3 and 5 to 7, the DSR may not comprise a fourth field. The fourth field comprises a value to indicate a value of the remaining time or a range of the remaining time of the data in an LCG.

Alternatively, in some implementations, the DSR may comprise the fourth field. The fourth field comprises a value to indicate a value of the remaining time or a range of the remaining time of the data in an LCG. Thus, the fourth field is also referred as a delay status field. Hereinafter, some implementations of the present disclosure will be described by taking the DSR comprising the fourth field for example. For example, the value may be the shortest remaining time of the data in the LCG.

In some implementations, the first set of LCGs may comprise multiple LCGs. If DSRs of the multiple LCGs are triggered, the UE 104 may include data volume associated with delay status for the multiple LCGs in the DSR in a decreasing order of priorities of the multiple LCGs. In other words, the UE 104 may prioritize the DSRs of the LCGs in a decreasing order of priorities of the LCGs. This implementation performs if a UL grant is not enough to accommodate all of the DSRs.

In some implementations, the UE 104 may determine a priority of an LCG as the highest priority of LCHs in the LCG. The LCH with the highest priority may have or may not have data available for transmission. Alternatively, the LCH with the highest priority may have or may not have delay status available for transmission. It is preferred that the LCH with the highest priority may have delay status available for transmission.

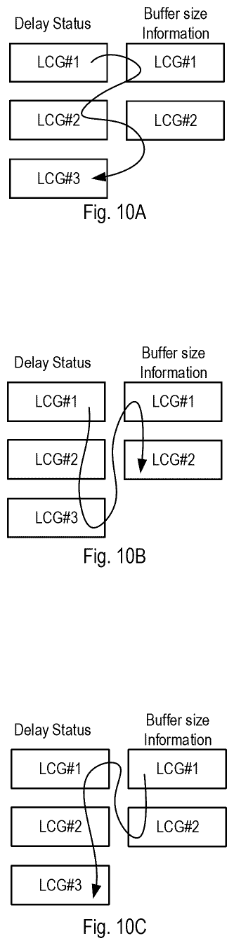

FIG. 10A illustrates an example of prioritizing of DSRs for multiple LCGs in accordance with aspects of the present disclosure. In the example of FIG. 10A, DSRs of LCG #1 and LCG #2, LCG #3 are triggered. A priority of LCG #1 is higher than a priority of LCG #2, and the priority of LCG #2 is equal to a priority of LCG #3. The UE 104 may first include data volume associated with delay status for LCG #1 and then include data volumes associated with delay status for LCG #2 and LCG #3.

In some implementations, the multiple LCGs may comprise a first LCG and a second LCG. If a first priority of the first LCG is equal to a second priority of the second LCG, the UE 104 may include the data volume associated with remaining time of data in the first LCG and the second LCG in the DSR in an increasing order of shortest remaining time of data in the first LCG and the second LCG. For example, in the example of FIG. 10A, the priority of LCG #2 is equal to the priority of LCG #3. If the shortest remaining time of data in LCG #2 is less than the shortest remaining time of data in LCG #3, the UE 104 may first include data volume associated with delay status for LCG #2 and then include data volumes associated with delay status for LCG #3. If the shortest remaining time of data in LCG #2 is greater than the shortest remaining time of data in LCG #3, the UE 104 may first include data volume associated with delay status for LCG #3 and then include data volumes associated with delay status for LCG #2.

In some implementations, the multiple LCGs may comprise a first LCG and a second LCG. If a first priority of the first LCG is equal to a second priority of the second LCG, the UE 104 may include the data volume associated with remaining time of data in the first LCG and the second LCG in the DSR in an increasing order of remaining time thresholds associated with the first LCG and the second LCG. For example, in the example of FIG. 10A, the priority of LCG #2 is equal to the priority of LCG #3. If a remaining time threshold associated with LCG #2 is less than a remaining time threshold associated with LCG #3, the UE 104 may first include data volume associated with delay status for LCG #2 and then include data volumes associated with delay status for LCG #3. If a remaining time threshold associated with LCG #2 is greater than a remaining time threshold associated with LCG #3, the UE 104 may first include data volume associated with delay status for LCG #3 and then include data volumes associated with delay status for LCG #2.

In some implementations, if DSRs of the multiple LCGs are triggered, the UE 104 may not consider priorities of the LCGs. In such implementations, the UE 104 may include data volume associated with remaining time of data in the multiple LCGs in the DSR in an increasing order of shortest remaining time of data in the multiple LCGs. This implementation performs if a UL grant is not enough to accommodate all of the DSRs.

For example, DSRs of LCG #1 and LCG #2, LCG #3 are triggered. A priority of LCG #1 is higher than a priority of LCG #2, and the priority of LCG #2 is equal to a priority of LCG #3. Remaining time of data in LCG #2 is greater than remaining time of data in LCG #3, and remaining time of data in LCG #3 is greater than remaining time of data in LCG #1. The UE 104 may first include a data volume associated with the remaining time of data in LCG #1, then include a data volume associated with the remaining time of data in LCG #3, and at last include a data volume associated with the remaining time of data in LCG #2.

Alternatively, in some implementations, if DSRs of the multiple LCGs are triggered, (the UE 104 may not consider priorities of the LCGs. In such implementations, the UE 104 may include data volume associated with remaining time of data in the multiple LCGs in the DSR in an increasing order of remaining time threshold for the multiple LCGs. This implementation performs if a UL grant is not enough to accommodate all of the DSRs.

For example, DSRs of LCG #1 and LCG #2, LCG #3 are triggered. A priority of LCG #1 is higher than a priority of LCG #2, and the priority of LCG #2 is equal to a priority of LCG #3. A remaining time threshold for LCG #2 is greater than data remaining time threshold for LCG #3, and the remaining time threshold for LCG #3 is greater than data remaining time threshold for LCG #1. The UE 104 may first include a data volume associated with the remaining time of data in LCG #1, then include a data volume associated with the remaining time of data in LCG #3, and at last include a data volume associated with the remaining time of data in LCG #2.

Alternatively, in some implementations, if DSRs of the multiple LCGs are triggered, and a UL grant is not enough to accommodate all of the DSRs, the UE 104 may first include remaining time of data in the multiple LCGs in the DSR in a decreasing order of priorities of the multiple LCGs, and then include data volumes associated with the remaining time in the DSR in the decreasing order of the priorities of the multiple LCGs. In other words, the UE 104 may first include delay status fields for the multiple LCGs in the DSR in a decreasing order of priorities of the multiple LCGs, and then include buffer size fields for the multiple LCGs in the DSR in the decreasing order of the priorities of the multiple LCGs. This will be described with reference to FIG. 10B.

FIG. 10B illustrates an example of prioritizing of DSRs for multiple LCGs in accordance with aspects of the present disclosure. In the example of FIG. 10B, DSRs of LCG #1 and LCG #2, LCG #3 are triggered. A priority of LCG #1 is higher than a priority of LCG #2, and the priority of LCG #2 is higher than a priority of LCG #3. The UE 104 may first include a delay status field for LCG #1, then include a delay status field for LCG #2, and at last include a delay status field for LCG #3. Later, the UE 104 may first include a buffer size field for LCG #1, and then include a buffer size field for LCG #2.

Alternatively, in some implementations, if DSRs of the multiple LCGs are triggered, the UE 104 may first include data volumes associated with the remaining time in the DSR in the decreasing order of the priorities of the multiple LCGs, and then include remaining time of data in the multiple LCGs in the DSR in a decreasing order of priorities of the multiple LCGs. In other words, the UE 104 may first include buffer size fields for the multiple LCGs in the DSR in the decreasing order of the priorities of the multiple LCGs, and then include delay status fields for the multiple LCGs in the DSR in a decreasing order of priorities of the multiple LCGs. This will be described with reference to FIG. 10C. This implementation performs if a UL grant is not enough to accommodate all of the DSRs.

FIG. 10C illustrates an example of prioritizing of DSRs for multiple LCGs in accordance with aspects of the present disclosure. In the example of FIG. 10C, DSRs of LCG #1 and LCG #2, LCG #3 are triggered. A priority of LCG #1 is higher than a priority of LCG #2, and the priority of LCG #2 is higher than a priority of LCG #3. The UE 104 may first include a buffer size field for LCG #1, and then include a buffer size field for LCG #2. Later, the UE 104 may first include a delay status field for LCG #1, then include a delay status field for LCG #2, and at last include a delay status field for LCG #3.

Alternatively, in some implementations, if DSRs of the multiple LCGs are triggered, and a UL grant is not enough to accommodate both remaining time of data for one of the multiple LCGs and a data volume associated with the remaining time, the UE 104 may exclude at least one of the remaining time and the data volume for the LCG. For example, both the remaining time and the data volume for the LCG are not included in the DSR. Alternatively, only the remaining time for the LCG is included in the DSR. Alternatively, only the data volume for the LCG is included in the DSR.

In some implementations, if both EBSR MAC CE and BSR MAC CE are allowed reported in a MAC PDU, the UE 104 may need to prioritize the EBSR MAC CE and legacy BSR MAC CE during the MAC PDU assembling if both are triggered. This implementation performs if a UL grant is not enough to accommodate all of the BSR and EBSR. A MAC sub-PDU include an EBSR MAC CE and MAC sub-header, either a field in the MAC CE or MAC sub-header indicate a new BS table information. For example, a MAC subheader except for fixed sized MAC CE consists of the header fields R/F/LCID/(eLCID)/L. A MAC subheader for fixed sized MAC CE, consists of the two header fields R/LCID/(eLCID). The Logical Channel ID field identifies the logical channel instance of the corresponding the type of the corresponding MAC CE.

In some implementation, the new buffer size table should include support for narrower ranges (i.e. granularity) than the legacy buffer size table. Network can configure which BSR table(s) an LCG is eligible to use. The new table have buffer size levels (in bytes) for 8-bit Buffer Size field. The UE 104 determines which BSR table (i.e. legacy or something else) the LCG should use.

In some implementations, a first EBSR MAC CE may have an additional field to indicate the new Buffer Size table information or the legacy Buffer Size table information corresponding to the buffer size for an LCG. For example, a bitmap field indicates the Buffer Size tables corresponding to the LCGs in the MAC CE, Bit i is corresponding to a Buffer Size table corresponding to LCG i in the MAC CE.

Alternatively, in some implementations, a second EBSR MAC CE may use legacy BSR MAC CE format with a new assigned LCH ID in the MAC sub-header associated with the BSR MAC CE if a new table is determined to be used for the BSR. The new LCH ID is different from the LCH ID in the MAC sub-header associated with the legacy BSR MAC CE(s). Table 2 gives an example of the new LCH ID.

TABLE 2

| Codepoint/Index | LCID values |
|---|---|
| 0 | CCCH of size 64 bits (referred to as “CCCH1” in |
| | TS 38.331 [5]), except for a RedCap UE |
| 59 | Short Truncated BSR |
| 60 | Long Truncated BSR |
| 61 | Short BSR |
| 62 | Long BSR |
| 64 | Release 18 BSR which can indicate new Buffer |
| | Size table information |

In some implementations, if only one MAC CE for data volume reporting in a MAC PDU, then either EBSR format or legacy BSR format may be used. For example, the EBSR format may be the first or second EBSR format.

In some implementations, if the UE 104 determines to use the new Buffer Size table at least for an LCG if BSR triggered and there are at least two LCGs with data available for transmission when the MAC PDU containing the BSR is to be built, first EBSR format is selected, i.e., report Long first EBSR for all LCGs which have data available for transmission.

For example, if the UE 104 triggered regular BSR, there are more than one LCGs with data available for transmission and a new BS table is determined to use for the BSR of one LCG, an old BS table is determined to use for the BSR of another LCG, UE report Long first EBSR for all LCGs which have data available for transmission. By using the first EBSR format can avoid reporting tow BSR MAC CEs to NW, lower signaling overhead is expected.

For example, if the UE 104 triggered padding BSR, there are more than one LCGs with data available for transmission when the BSR is to be built, and if a new BS table is determined to use for the BSR of at least one LCG, and if the number of padding bits is equal to or larger than the size of the Long first EBSR plus its subheader, and UE reports Long first EBSR for all LCGs which have data available for transmission.

For example, if the UE 104 triggered padding BSR, there are more than one LCGs with data available for transmission when the BSR is to be built, and if a new BS table is determined to use for the BSR of at least one LCG, and if the number of padding bits is larger than the size of the Short first EBSR plus its subheader but smaller than the size of the Long first EBSR plus its subheader, and UE reports Long Truncated first EBSR of the LCG(s) with the logical channels having data available for transmission following a decreasing order of the highest priority logical channel (with or without data available for transmission) in each of these LCG(s), and in case of equal priority, in increasing order of LCGID.

For example,

For Padding BSR, the MAC entity shall:

| 1> | if a new BS table is determined to report the BSR for at least one LCG, and | |
|---|---|---|
| 1> | if the number of padding bits is equal to or larger than the size of the Short first | |
| | EBSR plus its subheader but smaller than the size of the Long seond EBSR plus | |
| | its subheader: | |
| | 2> | if more than one LCG has data available for transmission when the BSR is to |

be built:

| | |
|---|---|
| 3> | if the number of padding bits is equal to the size of the Short first |

EBSR plus its subheader:

| | |
|---|---|
| 4> | report Short Truncated first EBSR of the LCG with the highest |

priority logical channel with data available for transmission.

| | |
|---|---|
| 3> | else: |

| | |
|---|---|
| 4> | report Long Truncated first EBSR of the LCG(s) with the logical |

channels having data available for transmission following a decreasing
order of the highest priority logical channel (with or without data
available for transmission) in each of these LCG(s), and in case of
equal priority, in increasing order of LCGID.

| | |
|---|---|
| 2> | else: |

| | |
|---|---|
| 3> | report Short first EBSR. |

| 1> | else if the number of padding bits is equal to or larger than the size of the Long | |
|---|---|---|
| | first EBSR plus its subheader: | |
| | 2> | report Long first EBSR for all LCGs which have data available for |

transmission.

In some implementations, if the UE 104 determines to use the old Buffer Size table for all LCGs if BSR triggered, legacy BSR format is selected.

In some implementations, if an EBSR MAC CE (e.g., second EBSR) and legacy MAC CE for data volume reporting is allowed in a MAC PDU, the UE 104 may use similar solutions as described with reference to FIGS. 8 and 9 by replacing the DSR with EBSR.

In such implementations, the UE 104 may transmit at least one of the EBSR and the BSR in a decreasing order of priorities of the EBSR and the legacy BSR. The UE 104 may prioritize the EBSR MAC CE and BSR MAC CE with a higher priority during a MAC PDU assembling. For example, if a UL grant is not enough to accommodate both of the EBSR and the BSR, the UE 104 may prioritize the EBSR MAC CE (e.g., second EBSR) and BSR MAC CE with a higher priority during a MAC PDU assembling. UE reports the buffer status for a first set of the LCGs in the EBSR. UE reports the buffer status for a second set of the LCGs in the legacy BSR.

In some implementations, the UE 104 may determine a first priority of the EBSR as a first highest priority of LCHs with data available for transmission in a first set of the LCGs. In addition, the UE 104 may determine a second priority of the legacy BSR as a second highest priority of logical channels (LCHs) with data available for transmission in a second set of LCGs.

In some implementations, if the first priority of the EBSR is equal to the second priority of the BSR, the UE 104 may prioritize the EBSR or BSR based on implementation of the UE 104. Alternatively, it may be pre-defined that the UE 104 prioritizes the EBSR or prioritizes the BSR.

In some implementations, for the regular BSR triggered for more than one LCGs, UE report EBSR format according to the number of the LCGs, which have data available for transmission and select the new Buffer Size table.

For example,

For Regular and Periodic BSR, the MAC entity shall:

| 1> | if more than one LCG has data available for transmission and selects the new Buffer Size table | |
|---|---|---|
| | when the MAC PDU containing the BSR is to be built: | |
| | 2> | report Long EBSR for all LCGs which have data available for transmission and selects the |

new Buffer Size table.

| | |
|---|---|
| 1> | else: |
| | 2>report Short EBSR. |

In some implementations, for the regular BSR triggered for more than one LCGs, UE report EBSR format according to the number of the LCGs, which have data available for transmission and select the legacy Buffer Size table.

For example,

For Regular and Periodic BSR, the MAC entity shall:

| 1> | if more than one LCG has data available for transmission and selects the legacy Buffer Size | |
|---|---|---|
| | table when the MAC PDU containing the BSR is to be built: | |
| | 2> | report Long EBSR for all LCGs which have data available for transmission and selects the |

leagcy Buffer Size table.

| | |
|---|---|
| 1> | else: |
| | 2>report Short EBSR. |

Alternatively, in some implementations, the UE 104 may determine the priorities of the EBSR and the BSR based on types of the EBSR and the BSR.

In some implementations, a type of the EBSR may be one of the following: a Regular EBSR, a Periodic EBSR or a Padding EBSR, which type of EBSR is triggered following the legacy BSR trigger events in TS 38.321.

In some implementations, priorities between Regular/Periodic/Padding EBSR and legacy Regular/Periodic/Padding BSR may be defined as shown in Table 2.

TABLE 2

| | Regular BSR | Periodic BSR | Padding BSR |
|---|---|---|---|
| Regular EBSR | >, ==, or < | >, ==, or < | >, ==, or < |
| Padding EBSR | >, ==, or < | >, ==, or < | >, ==, or < |
| Periodic EBSR | >, ==, or < | >, ==, or < | >, ==, or < |

In Table 2, “>” represents a priority of a BSR is higher than a priority of a DSR or a priority of a DSR is higher than a priority of a BSR, “==” represents a priority of a BSR is equal to a priority of a DSR, and “<” represents a priority of a BSR is lower than a priority of a DSR or a priority of a DSR is lower than a priority of a BSR.

In some implementations, it is not preferred that a priority of a Regular EBSR is equal to a priority of a Padding BSR.

In some implementations, it is not preferred that a priority of a Regular EBSR is lower than a priority of a Padding BSR.

In some implementations, it is not preferred that a priority of a Padding EBSR is higher than a priority of a Regular BSR.

In some implementations, it is not preferred that a priority of a Padding EBSR is equal to a priority of a Regular BSR.

In some implementations, it is not preferred that a priority of a Periodic EBSR is lower than a priority of a Padding BSR.

In some implementations, it is not preferred that a priority of a Periodic EBSR is equal to a priority of a Padding BSR.

Alternatively, in some implementations, if the reporting of the EBSR is triggered for the first set of LCGs and reporting of a BSR is triggered for a second set of LCGs, the UE 104 may transmit at least one of the EBSR and the BSR in a decreasing order of the highest priority logical channel with data available for transmission in each of the LCGs in the first and second sets of LCGs, the second set of LCGs comprising one or more LCGs.

In such implementations, the highest priority logical channel in each of the LCGs in the first set of LCGs has data available for transmission. In such implementations, the highest priority logical channel in each of the LCGs in the second set of LCGs has data available for transmission.

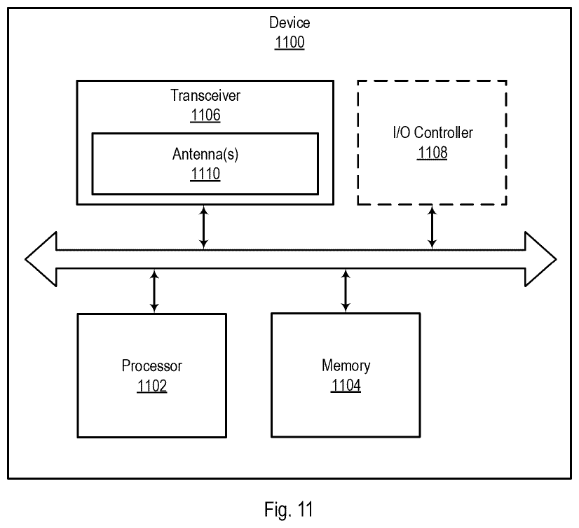

In such implementations, the UE 104 may determine a first priority of the EBSR as a first highest priority of LCHs with data available for transmission in the first set of LCGs with data available for transmission. In addition, the UE 104 may determine a second priority of the BSR as a second highest priority of LCHs with data available for transmission in a second set of LCGs with data available for transmission. The second set of LCGs comprises one or more LCGs. FIG. 11 illustrates an example of a device 1100 that supports delay report and discarding based on a synchronization transmission set in accordance with aspects of the present disclosure. The device 1100 may be an example of a base station 102 or a UE 104 as described herein. The device 1100 may support wireless communication with one or more network entities 102, UEs 104, or any combination thereof. The device 1100 may include components for bi-directional communications including components for transmitting and receiving communications, such as a processor 1102, a memory 1104, a transceiver 1106, and, optionally, an I/O controller 1108. These components may be in electronic communication or otherwise coupled (e.g., operatively, communicatively, functionally, electronically, electrically) via one or more interfaces (e.g., buses).

The processor 1102, the memory 1104, the transceiver 1106, or various combinations thereof or various components thereof may be examples of means for performing various aspects of the present disclosure as described herein. For example, the processor 1102, the memory 1104, the transceiver 1106, or various combinations or components thereof may support a method for performing one or more of the operations described herein.

In some implementations, the processor 1102, the memory 1104, the transceiver 1106, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1102 and the memory 1104 coupled with the processor 1102 may be configured to perform one or more of the functions described herein (e.g., executing, by the processor 1102, instructions stored in the memory 1104).

For example, the processor 1102 may support wireless communication at the device 1100 in accordance with examples as disclosed herein. The processor 1102 may be configured to operable to support a means for performing the following: triggering, at a UE, reporting of a DSR; and transmitting, to a base station, the DSR indicating delay status for a first set of LCGs, the first set of LCGs comprising one or more LCGs.

Alternatively, in some implementations, the processor 1102 may be configured to operable to support a means for performing the following: transmitting a configuration of a DSR to a UE; and receiving, from the UE, the DSR indicating delay status for a first set of LCGs, the first set of LCGs comprising one or more LCGs.

The processor 1102 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1102 may be configured to operate a memory array using a memory controller. In some other implementations, a memory controller may be integrated into the processor 1102. The processor 1102 may be configured to execute computer-readable instructions stored in a memory (e.g., the memory 1104) to cause the device 1100 to perform various functions of the present disclosure.

The memory 1104 may include random access memory (RAM) and read-only memory (ROM). The memory 1104 may store computer-readable, computer-executable code including instructions that, when executed by the processor 1102 cause the device 1100 to perform various functions described herein. The code may be stored in a non-transitory computer-readable medium such as system memory or another type of memory. In some implementations, the code may not be directly executable by the processor 1102 but may cause a computer (e.g., when compiled and executed) to perform functions described herein. In some implementations, the memory 1104 may include, among other things, a basic I/O system (BIOS) which may control basic hardware or software operation such as the interaction with peripheral components or devices.

The I/O controller 1108 may manage input and output signals for the device 1100. The I/O controller 1108 may also manage peripherals not integrated into the device M02. In some implementations, the I/O controller 1108 may represent a physical connection or port to an external peripheral. In some implementations, the I/O controller 1108 may utilize an operating system such as iOS®, ANDROID®, MS-WINDOWS®, OS/2®, UNIX®, LINUX®, or another known operating system. In some implementations, the I/O controller 1108 may be implemented as part of a processor, such as the processor 1106. In some implementations, a user may interact with the device 1100 via the I/O controller 1108 or via hardware components controlled by the I/O controller 1108.

In some implementations, the device 1100 may include a single antenna 1110. However, in some other implementations, the device 1100 may have more than one antenna 1110 (i.e., multiple antennas), including multiple antenna panels or antenna arrays, which may be capable of concurrently transmitting or receiving multiple wireless transmissions. The transceiver 1106 may communicate bi-directionally, via the one or more antennas 1110, wired, or wireless links as described herein. For example, the transceiver 1106 may represent a wireless transceiver and may communicate bi-directionally with another wireless transceiver. The transceiver 1106 may also include a modem to modulate the packets, to provide the modulated packets to one or more antennas 1110 for transmission, and to demodulate packets received from the one or more antennas 1110. The transceiver 1106 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 1110 for transmitting the amplified signal into the air or wireless medium.

A receive chain may be configured to receive signals (e.g., control information, data, packets) over a wireless medium. For example, the receive chain may include one or more antennas 1110 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

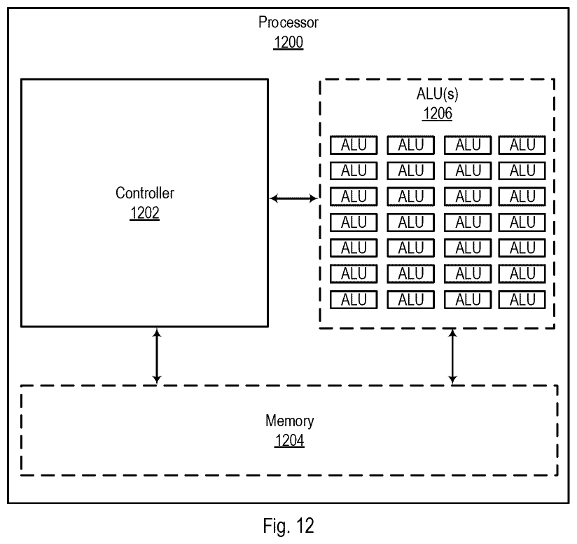

FIG. 12 illustrates an example of a processor 1200 that supports delay report and discarding based on a synchronization transmission set in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, such as L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementation, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementation, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communication in accordance with examples as disclosed herein. The processor 1200 may be configured to operable to support a means for performing the following: triggering, at a UE, reporting of a DSR; and transmitting, to a base station, the DSR indicating delay status for a first set of LCGs, the first set of LCGs comprising one or more LCGs.

Alternatively, in some implementations, the processor 1200 may be configured to operable to support a means for performing the following: transmitting a configuration of a DSR to a UE; and receiving, from the UE, the DSR indicating delay status for a first set of LCGs, the first set of LCGs comprising one or more LCGs.

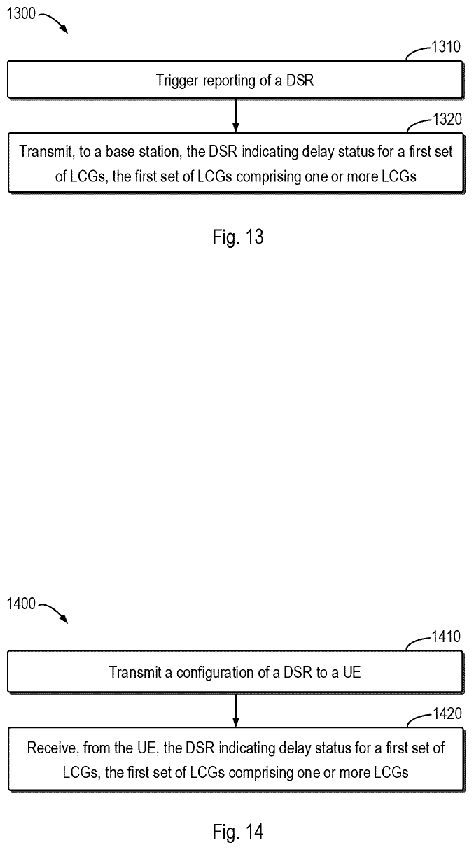

FIG. 13 illustrates a flowchart of a method 1300 that supports delay report in accordance with aspects of the present disclosure. The operations of the method 1300 may be implemented by a device or its components as described herein. For example, the operations of the method 1300 may be performed by a UE 104 as described herein. In some implementations, the device may execute a set of instructions to control the function elements of the device to perform the described functions. Additionally, or alternatively, the device may perform aspects of the described functions using special-purpose hardware.

At 1310, the method may include triggering reporting of a DSR. The operations of 1310 may be performed in accordance with examples as described herein. In some implementations, aspects of the operations of 1310 may be performed by a device as described with reference to FIG. 1.

At 1320, the method may include transmitting, to a base station, the DSR indicating delay status for a first set of LCGs. The first set of LCGs comprises one or more LCGs. The operations of 1320 may be performed in accordance with examples as described herein. In some implementations, aspects of the operations of 1320 may be performed by a device as described with reference to FIG. 1.

FIG. 14 illustrates a flowchart of a method 1400 that supports delay report in accordance with aspects of the present disclosure. The operations of the method 1400 may be implemented by a device or its components as described herein. For example, the operations of the method 1400 may be performed by a base station 102 as described herein. In some implementations, the device may execute a set of instructions to control the function elements of the device to perform the described functions. Additionally, or alternatively, the device may perform aspects of the described functions using special-purpose hardware.

At 1410, the method may include transmitting a configuration of a DSR to a UE. The operations of 1410 may be performed in accordance with examples as described herein. In some implementations, aspects of the operations of 1410 may be performed by a device as described with reference to FIG. 1.

At 1420, the method may include receiving, from the UE, the DSR indicating delay status for a first set of LCGs, the first set of LCGs comprising one or more LCGs. The operations of 1420 may be performed in accordance with examples as described herein. In some implementations, aspects of the operations of 1420 may be performed by a device as described with reference to FIG. 1.

It shall be noted that implementations of the present disclosure which have been described with reference to FIGS. 2 to 10C are also applicable to the device 1100, the process 1200 and the methods 1300 and 1400.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
trigger reporting of a delay status report (DSR); and
transmit, to a base station, the DSR indicating a delay status for a first set of logical channel groups (LCGs), wherein the first set of LCGs comprises one or more LCGs.

2. The UE of claim 1, wherein each of the LCGs in the first set has a respective DSR available for transmission; or
wherein each of the LCGs in the first set is configured with reporting of a respective DSR and has data available for transmission; or
wherein each of the LCGs in the first set has data available for transmission.

3. The UE of claim 1, wherein the DSR comprises a first field comprising a first bitmap, wherein each bit in the first bitmap is associated with one of the LCGs, and wherein each bit indicates:
whether a respective one of the LCGs has data available for transmission, or
whether reporting of a respective DSR for the respective one of the LCGs is triggered, or
whether a third field for the respective one of the LCGs is present in the DSR, the third field indicates a data volume of a set of data available for transmission in the respective one of the LCGs.

4. The UE of claim 3, wherein the LCGs are configured for the UE or configured to allow reporting of DSRs.

5. The UE of claim 1, wherein the DSR comprises a second field comprising a second bitmap, wherein seach bit in the second bitmap is associated with one of the LCGs, and wherein each bit indicates whether reporting of a respective DSR for a respective one of the LCGs is triggered.

6. The UE of claim 1, wherein the DSR comprises a third field, and the third field indicates:
a first data volume of a first set of data available for transmission in a respective one of the LCGs, wherein a remaining time of data in the first set of data is below a first remaining time threshold for the respective one of the LCGs,
a second data volume of a second set of data available for transmission in the respective one of the LCGs, wherein a remaining time of data in the second set is below the first remaining time threshold and is the shortest among remaining time of data available for transmission in the one of the LCGs,
a third volume of data available for transmission in the respective one of the LCGs, wherein a respective DSR is not triggered or reporting of the respective DSR is not configured for the respective one of the LCGs, or
a fourth data volume of a third set of data available for transmission in the respective one of the LCGs, wherein a remaining time of data in the third set of data is the shortest among remaining time of data available for transmission in the respective one of the LCGs, wherein a respective DSR is not triggered or reporting of the respective DSR is not configured for the respective one of the LCGs.

7. The UE of claim 1, wherein the at least one processor is further configured to cause the UE to:
based on determining that the reporting of the DSR is triggered and reporting of a buffer status report (BSR) is triggered, transmit at least one of the DSR and the BSR in a decreasing order of priorities of the DSR and the BSR.

8. The UE of claim 7, wherein the at least one processor is further configured to cause the UE to:
determine a first priority of the DSR as a first highest priority of logical channels (LCHs) with delay status available for transmission in the first set of LCGs with delay status available for transmission; and
determine a second priority of the BSR as a second highest priority of LCHs with data available for transmission in a second set of LCGs with data available for transmission, the second set of LCGs comprising one or more LCGs.

9. The UE of claim 7, wherein the at least one processor is further configured to cause the UE to:
determine the priorities of the DSR and the BSR based on types of the DSR and the BSR.

10. The UE of claim 1, wherein the at least one processor is further configured to cause the UE to:
based on determining that the reporting of the DSR is triggered for the first set of LCGs and reporting of a buffer status report (BSR) is triggered for a second set of LCGs, transmit at least one of the DSR and the BSR in a decreasing order of a highest priority logical channel in each of the LCGs in the first and second sets of LCGs, wherein the second set of LCGs comprises one or more LCGs.

11. The UE of claim 1, wherein the first set of LCGs comprises multiple LCGs, and wherein the at least one processor is further configured to cause the UE to:
include a data volume associated with the delay status for the multiple LCGs in the DSR in a decreasing order of priorities of the multiple LCGs.

12. The UE of claim 11, wherein the at least one processor is further configured to cause the UE to:
determine a priority of an LCG among the multiple LCGs as a highest priority of logical channels (LCHs) with the delay status available for transmission in the LCG.

13. The UE of claim 11, wherein the multiple LCGs comprise a first LCG and a second LCG, and wherein the at least one processor is configured to cause the UE to include the data volume associated with the delay status for the multiple LCGs by:
based on determining that a first priority of the first LCG is equal to a second priority of the second LCG, including the data volume associated with remaining time of data in the first LCG and the second LCG in the DSR in an increasing order of:
a shortest remaining time of data in the first LCG and the second LCG, or
remaining time thresholds associated with the first LCG and the second LCG.

14. The UE of claim 1, wherein the first set of LCGs comprises multiple LCGs, and wherein the at least one processor is further configured to cause the UE to:
include data volume associated with remaining time of data in the multiple LCGs in the DSR in an increasing order of:
a shortest remaining time of data in the multiple LCGs, or
remaining time thresholds associated with the multiple LCGs.

15. The UE of claim 1, wherein the first set of LCGs comprises multiple LCGs, and wherein the at least one processor is further configured to cause the UE to:
after including remaining time of data in the multiple LCGs in the DSR in a decreasing order of priorities of the multiple LCGs, including data volumes associated with the remaining time in the DSR in the decreasing order of the priorities of the multiple LCGs; or
before including remaining time of data in the multiple LCGs in the DSR in a decreasing order of priorities of the multiple LCGs, including data volumes associated with the remaining time in the DSR in the decreasing order of the priorities of the multiple LCGs.

16. (canceled)

17. The UE of claim 1, wherein the first set of LCGs comprises multiple LCGs, and wherein the at least one processor is further configured to cause the UE to:
based on determining that an uplink grant is not enough to accommodate the remaining time of data for one of the multiple LCGs and a data volume associated with the remaining time, exclude at least one of the remaining time and the data volume for the LCG.

18. A base station for wireless communication, comprising:
at least one memory; and
at least one processor coupled with the at least one memory and configured to cause the UE to:
transmit a configuration of a delay status report (DSR) to a user equipment (UE); and
receive, from the UE, the DSR indicating a delay status for a first set of logical channel groups (LCGs), wherein the first set of LCGs comprises one or more LCGs.

19. A processor for wireless communication, comprising:
a controller coupled with at least one memory and configured to cause the controller to:
trigger reporting of a delay status report (DSR); and
transmit, to a base station, the DSR indicating a delay status for a first set of logical channel groups (LCGs), wherein the first set of LCGs comprises one or more LCGs.

20. A method performed by a user equipment (UE), the method comprising:
triggering reporting of a delay status report (DSR); and
transmitting, to a base station, the DSR indicating a delay status for a first set of logical channel groups (LCGs), wherein the first set of LCGs comprises one or more LCGs.

21. The UE of claim 1, wherein the at least one processor is configured to cause the UE to not include the delay status in the DSR when a data volume for an LCG of the first set of LCGs is zero when a remaining time of the LCG is zero.
